(19) United States
(12) Patent Application Publication
(10) Pub. No.: US 2020/0129791 A1
(43) Pub. Date: Apr. 30, 2020

(54) TREE SAFETY DEVICE

(71) Applicant: McMaster Outdoors, LLC, Shreveport, LA (US)

(72) Inventors: James Anthony MCMASTER, Shreveport, LA (US); Kevin MCMASTER, Shreveport, LA (US)

(21) Appl. No.: 16/578,538

(22) Filed: Sep. 23, 2019

Related U.S. Application Data
(60) Provisional application No. 62/753,109, filed on Oct. 31, 2018.

(51) Int. Cl. A62B 35/00

(52) U.S. Cl. CPC A62B 35/0093

(57) ABSTRACT

A tree safety device comprising a housing, a holder attached to the housing to hold the device to a tree, an automatic breaking retractor inside of the housing, a cable, with a first end attached to the retracting device and a second end extending out of the housing, a latch attached the second end of the line, wherein the retractor allows for the cable to be fed from the housing at a rate below a predetermined speed, but automatically breaks the cable from feeding out of the housing if the rate exceeds the predetermined speed.

### CROSS REFERENCE TO RELATED APPLICATIONS/PRIORITY

The present invention claims priority to U.S. Provisional Patent Application No. 62/753,109 filed Oct. 31, 2018, which is incorporated by reference into the present disclosure as if fully restated herein. Any conflict between the incorporated material and the specific teachings of this disclosure shall be resolved in favor of the latter. Likewise, any conflict between an art-understood definition of a word or phrase and a definition of the word or phrase as specifically taught in this disclosure shall be resolved in favor of the latter.

### BACKGROUND

For hunting, a hunter generally positions himself or herself at an elevated position, between ten and thirty feet above the ground, by using a tree stand. A tree stand is basically a seat and footrest unit that is either strapped to a tree or its branches. Climbing to and from the tree stand can be dangerous, as a majority of tree stand accidents happen during the climb up or down the tree.

### SUMMARY OF THE INVENTION

The present disclosure relates, generally, to a tree safety device. More particularly, the present disclosure relates to a tree safety device suitable for protecting a hunter from a fall during hunting, including climbing up to and down from a tree stand.

The presently claimed invention relates to methods and devices comprising a housing, a holder attached to the housing to hold the device to a tree, an automatic breaking retractor inside of the housing, a cable, with a first end attached to the retracting device and a second end extending out of the housing, a latch attached the second end of the line, wherein the retractor allows for the cable to be fed from the housing at a rate below a predetermined speed, but automatically breaks the cable from feeding out of the housing if the rate exceeds the predetermined speed. According to a further embodiment the housing has a first side that is concave to fit increase surface area in contact with the tree. According to a further embodiment the housing has a tree first side designed to contact the tree, and wherein projections are disposed on an exterior surface of the first side. According to a further embodiment the holder incudes a strap. According to a further embodiment the holder includes a ratchet that tightens the strap. According to a further embodiment the strap has protrusions on a tree facing inner surface of the strap. According to a further embodiment the tree safety device comprises one or more hooks or rings disposed on the strap. According to a further embodiment the tree safety device comprises a groove channel disposed on an exterior surface of a second side of the housing to position the strap around a front of safety device facing away from the tree. According to a further embodiment the housing comprises a first and a second handle defining a first and a second through hole in housing, such that the strap is fed through each of the first and the second through hole, with the first and the second handle being of unitary construction with the housing. According to a further embodiment the cable has one of glow in the dark material and highly reflective material, between 6 inches and 18 inches in length, adjacent to the second end of the chord to allow the chord to be to be more easily seen with a flashlight in the dark According to a further embodiment the interior is substantially isolated from the weather, with any open hole into the interior positioned on a ground facing side According to a further embodiment the safety device comprises a carabiner back up attachment at top of the housing. According to a further embodiment, projections are one of teeth that angle downward when attached to a tree and spikes that are arranged orthogonal to the housing surface. According to a further embodiment the housing is UV resistant and weather resistant. According to a further embodiment the strap is weather and UV resistant. According to a further embodiment the housing is one of camouflaged and orange. According to a further embodiment the safety device comprises a retention assembly including a first arm and a second arm that engage the tree frictionally retain the device. According to a further embodiment the first and second arms are mechanized and automatically grip the tree once the device is placed adjacent to the tree. According to a further embodiment the retractor defines a retractor through hole that is aligned with a third through hole in top of the housing. According to a further embodiment the carabiner back up attachment includes a first hook that attaches to the housing at the third through hole.

Various objects, features, aspects, and advantages of the present invention will become more apparent from the following detailed description of preferred embodiments of the invention, along with the accompanying drawings in which like numerals represent like components. The present invention may address one or more of the problems and deficiencies of the current technology discussed above. However, it is contemplated that the invention may prove useful in addressing other problems and deficiencies in a number of technical areas. Therefore the claimed invention should not necessarily be construed as limited to addressing any of the particular problems or deficiencies discussed herein.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. It is to be appreciated that the accompanying drawings are not necessarily to scale since the emphasis is instead placed on illustrating the principles of the invention. The invention will now be described, by way of example, with reference to the accompanying drawings in which:

FIG. 1 illustrates a tree safety device attached to a tree and a hunter standing on a tree stand, in accordance with an embodiment of the disclosure;

FIG. 2 illustrates a front perspective view of the tree safety device, in accordance with an embodiment of the disclosure;

FIG. 3 illustrates a rear perspective view of the tree safety device depicting a tree facing side of a housing of the tree safety device, in accordance with an embodiment of the disclosure;

FIG. 4 illustrates the tree facing side having a plurality of projections; in accordance with an embodiment of the disclosure;

FIG. 5 illustrates a rear perspective view of the tree safety device depicting a plurality of arms extending from the housing, in accordance with an embodiment of the disclosure;

FIG. 6 is a perspective view of a retracting device of the tree safety device, in accordance with an embodiment of the disclosure;

FIG. 7 is an exploded view of the retracting device depicting a spring attached to a shaft and a first disk, in accordance with an alternative embodiment of the disclosure;

FIG. 8 illustrates an exploded view of the retracting device depicting levers of a locking assembly of the retracting device, in accordance with an embodiment of the disclosure; and

FIG. 9 illustrates an exploded view of the retracting device depicting a ratchet wheel of the locking assembly, in accordance with an embodiment of the disclosure.

### DETAILED DESCRIPTION

The present invention will be understood by reference to the following detailed description, which should be read in conjunction with the appended drawings. It is to be appreciated that the following detailed description of various embodiments is by way of example only and is not meant to limit, in any way, the scope of the present invention. In the summary above, in the following detailed description, in the claims below, and in the accompanying drawings, reference is made to particular features (including method steps) of the present invention. It is to be understood that the disclosure of the invention in this specification includes all possible combinations of such particular features, not just those explicitly described. For example, where a particular feature is disclosed in the context of a particular aspect or embodiment of the invention or a particular claim, that feature can also be used, to the extent possible, in combination with and/or in the context of other particular aspects and embodiments of the invention, and in the invention generally. The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm. The embodiments set forth the below represent the necessary information to enable those skilled in the art to practice the invention and illustrate the best mode of practicing the invention. In addition, the invention does not require that all the advantageous features and all the advantages need to be incorporated into every embodiment of the invention.

Reference will be made to the figures, showing various embodiments of the fixture and methods for using thereof.

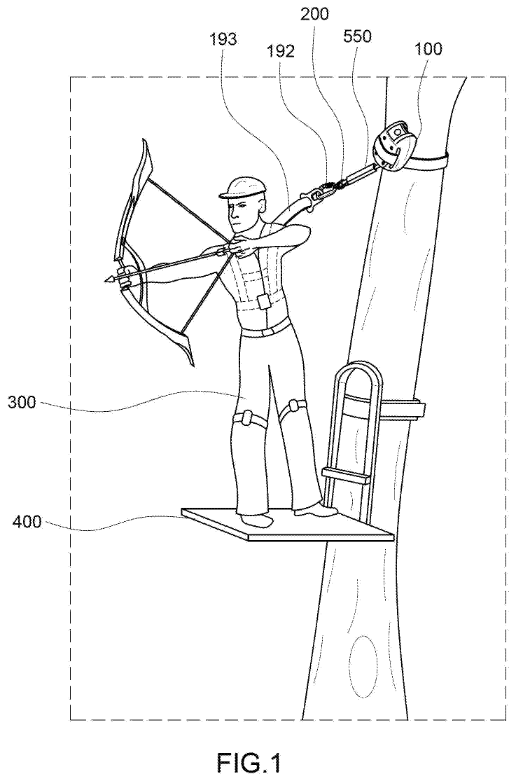

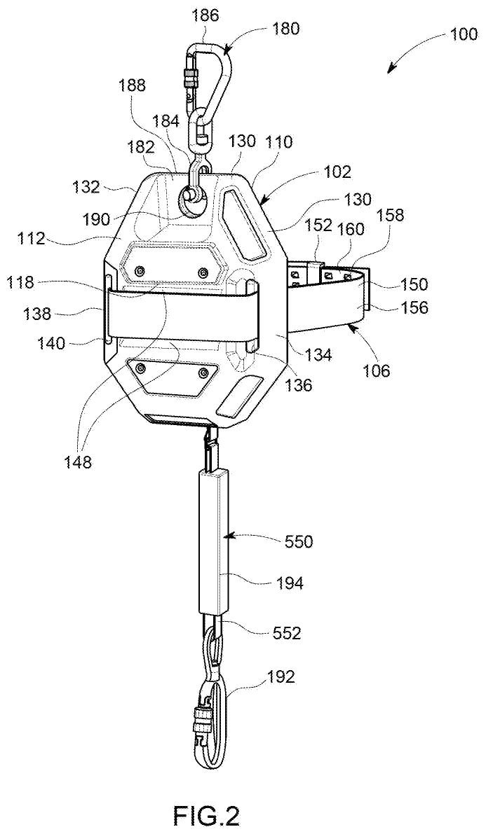

Referring to FIG. 1, a tree safety device 100 (hereinafter referred to as a device 100) attached to a tree 200 and a hunter 300 for protecting the hunter 300 from falling from a tree stand 400 during hunting is shown. The device 100 is also adapted to hold the hunter 300 and prevent the hunter 300 from falling from a tree during a climb up a tree stand 400 from the ground, while on the tree stand 400, and during a climb down from the tree stand 400 to the ground. Referring to FIGS. 2, 3, 4, and 5, the device 100 includes a housing 102 and a holder 106 attached to the housing 102 and adapted to attach or affix the housing 102 to the tree 200. The housing 102 includes a body 110 defining a chamber for receiving and housing one or more components or assembly of the device 100. In an embodiment, the body 102 may be formed by assembling two half portions 112, 114, and may be made of acrylonitrile butadiene styrene, polyoxymethylene, polypropylene, High-impact polystyrene, low-density polyethylene, or any other similar plastic. In an embodiment, the housing 102 includes a material having ultraviolet (UV) resistant and weather resistant properties, either in the material the body 110 is constructed of and/or in a coating applied to the materials. In an embodiment, a paint or coating may be applied on an outer or exterior surface 122 of the housing 102 to facilitate a glowing of the housing 102 under darkness. In an embodiment, the outer surface 122, or a paint or coating applied thereto may include an orange color, and/or may facilitate camouflaging of the housing 102 within an ambient environment, such as a brown to match a tree bark.

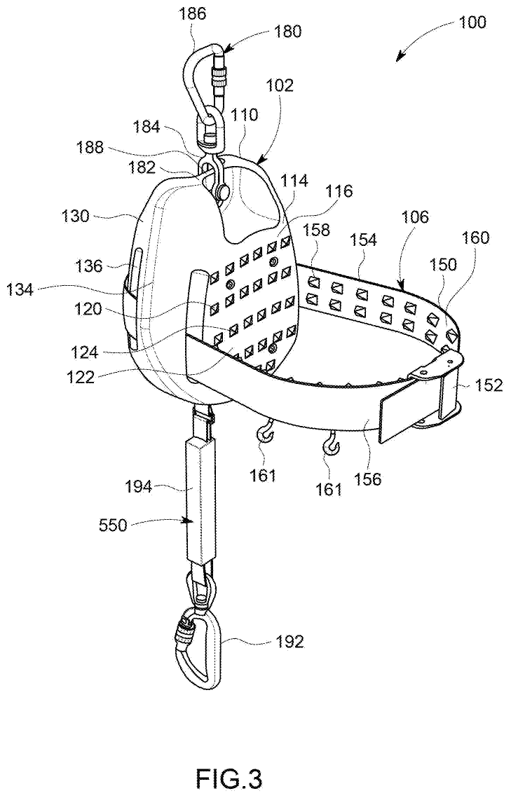

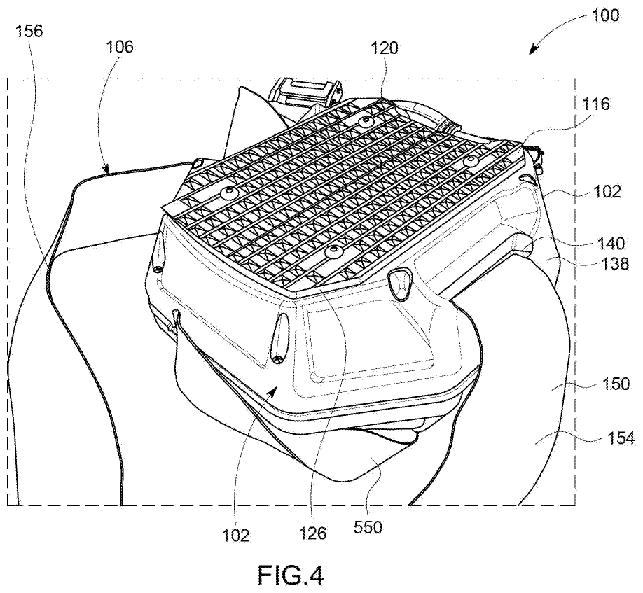

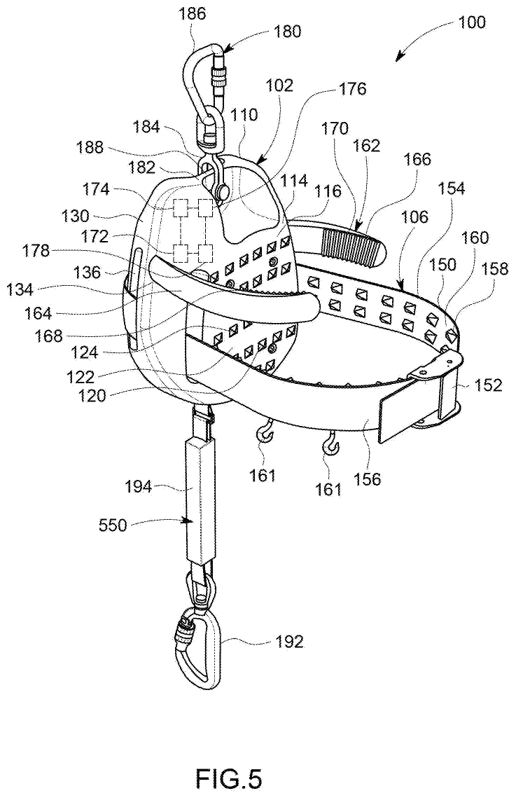

The housing 102 includes a first side 116 (also referred to as a tree facing back side 116) adapted to contact/abut the tree 200 and a second side 118 disposed spaced apart and opposite to the first side 116. In an embodiment, the first side 116 is a concave side, and includes a concavity to facilitate a relatively increased contact surface area with the tree 200 to provide an increased frictional engagement between the housing 102 and tree 200. In an embodiment, the first side 116 may also include a plurality of projections 120 (shown in FIGS. 3 and 5) extending outwardly from the outer surface 122 of the first side 116. The projections 120 may be adapted to embed, at least partially, into the tree 200 when the first side 116 engages/contacts the tree 200, thereby increasing the friction between the housing 102 and the tree 200. In this manner, the projections 120 may facilitate increased frictional engagement between the housing 102 and tree 200, and thereby facilitating a retention of the housing 102 with the tree 200. In an embodiment, the projections 120 may be teeth 124 that angle downwardly towards the ground from the surface 122. In some other implementations, the projections 120 may be spikes extending orthogonally from the surface 122. In an embodiment, the projections 120 may be integrally formed to the first side 116 of the housing 102. Alternatively, the projections 120 may be formed on a plate 126 (as shown in FIG. 4) and the plate 126 is attached to the first side 116. Further, the body 110 may include a third side 130 extending from the first side 116 to the second side 118, and connecting the first side 116 to the second side 118. The body 110 also includes a fourth side 132 extending from the first side 116 to the second side 118 and connecting the first side 116 to the second side 118. As shown, the fourth side 132 may be disposed spaced apart from the third side 130 and is located opposite to the third side 130.

The housing 102 further includes a first handle 134 integrally formed on the third side 130 of the housing 102 and defining a first though hole 136. The first handle 130 extends in a longitudinal direction of the housing 102 such that the first through hole 136 extends laterally to the third side 130. In this manner, the first through hole 136 extends along a width of third side 130. Similarly, the housing 102 further includes a second handle 138 integrally formed on the fourth side 132 of the housing 102 and defining a second though hole 140 between the fourth side 132 and the second handle 138. The second handle 138 extends in a longitudinal direction of the housing 102 such that the second through hole 140 extends laterally to the fourth side 132. In this manner, the second through hole 140 extends along a width of the fourth side 132. The first though hole 132 and the second through hole 140 facilitates an attachment of the holder 106 with the housing 102. A groove channel 148 may be formed along the outer surface 122 of the second side 118, generally forming a path for the holder between the first though hole 132 and the second through hole 140.

In an embodiment, the holder 106 may include a strap 150 and ratchet 152 for tightening the strap 150 around the tree 200. As shown, the strap 150 may pass through the first though hole 136 and the second though hole 140, and may wrap around the second side 118, the third side 130 and the fourth side 132. The strap 150 may include a first end portion 154 and a second end portion 156 adapted to wrap around the tree 200 to attach the housing 102 with the tree 200. To facilitate a secure attachment of the strap 150 to the tree 200, the first end portion 154 is attached to the second portion 156 by using the ratchet 152. In an embodiment, the ratchet 152 may be connected and disposed at the second end portion 156. For connecting the first end portion 154 to the second end portion 156 and tightening the strap 150, the first end portion 154 is inserted into the ratchet 152 and pulled through the ratchet 152, and the ratchet 152 is engaged until the strap 150 is sufficiently taunt. In an embodiment, the first end portion 154 and the second portion 156 may include a plurality of teeth 158, spikes, or other protrusions extending from an inner surface 160 of the strap 150 to increase a frictional engagement between the strap 150 and the tree 200. In an embodiment, rivets may be disposed on the strap 150 to allow a stainless-steel nail, or other rust proof/resistant nail or fastener to be driven through and firmly attach the strap 150 to the tree 200. Further, in an embodiment, the strap 150 may include one or more hooks 161 or rings attached thereto, to allow the hunter 300 to hang one or more items to the holder 106. In some embodiments, the strap 150 may be weather resistant and ultraviolet (UV) resistant.

Additionally, or optionally, the device 100 may include a retention assembly 162 (shown in FIG. 5) for facilitating an attachment and retention of the housing 102 with the tree 200. As shown, the retention assembly 162 may include a pair of arms, for example, a first arm 164 and a second arm 166, extending outwardly from the housing 102 and adapted to engage, lock, and hold the tree 200. In this manner, the arms 164, 166 may act as claws that wrap around the tree 200 and thereby facilitate the holding of the housing 102 with the tree 200. In an embodiment, the first arm 164 includes an end portion disposed away from the housing 102, and having a plurality of first spikes or teeth 168 adapted to embed into the tree 200 to securely engage the housing 102 with the tree 200. Similarly, the second arm 166 may include an end portion having a plurality of second spikes or teeth 170 adapted to embed into the tree 200 to securely engage the housing 102 with the tree 200. In the embodiment shown in FIG. 5, the teeth 170 are arranged in a series perpendicular to the ground, which aids in the arms 164, 166 from being pulled away from the tree 200 once engaged. In other embodiments, the teeth may be arranged parallel to the ground, which aids in the arms resisting being pulled downward from the weight of the hunter. In a further embodiment the teeth 170 could be arranged sloping downward and away from the device 100, going from a top of the arm 164, 166 to a bottom of the arm 164, 166. This would cause any downward pulling on the arms 164, 166 to urge the arms 164, 166 to grip further around the tree 200 and thus tighten the grip of the device 100 on the tree 200. The retention assembly 162 may include a gear assembly 172 and one or more motors 174 for operating the arms 164, 166. The gear assembly 172 may include one or more gears, such as, a worm gear, to facilitate the movements of the arms. A metal bar or component may connect the two arms 164, 166 from the inside of the interior, so as to provide increased structural support for the torque carried by the arms 164, 166. Further, the gear assembly 172 are operated/moved by operating the motor 174. In an embodiment, the device 100 may include a battery 176 disposed inside the housing 102 to power the motor 174. In an embodiment, the arms 164, 166 automatically unfold and grip the tree 200 once the device 100 is placed adjacent to the tree 200. For so doing, the retention assembly 162 may include one or more proximity sensors 178 or proximity switches that causes an operation of the motor 174 to open/unfold the arms 164, 166 once the housing 102 touches the tree 102 or within a predetermined distance from the tree 102. A processor and memory may also be present to control the engagement of the arms. In an embodiment, the arms may function as pincers, and embed between 0.5 inches and 4.0 inches of a leading end into the tree. Additionally, though teeth 170 are shown, spikes could be used in place of or in addition to the teeth 170.

Additionally, or optionally, the device 100 includes a carabiner back up attachment 180 for attaching the housing 102 to the tree 200. The carabiner back up attachment 180 is attached to a top end 182 of the housing 102, and includes a first hook 184 attached to the top end 182 of the housing 102 and a second hook 186 connected to the first hook 184 and adapted to be coupled to the tree 200. In an embodiment, the carabiner back up attachment 180 may include a cord or a rope extending between the first hook 184 and the second hook 186 and attached to the first hook 184 and the second hook 186. To facilitate the attachment of the first hook 184 to the housing 102, the housing 102 may include a hook portion 188. The hook portion 188 may define a third though hole 190 for receiving the first hook 184 and facilitating the attachment of the first hook 184 with the housing 102. The second hook 186 is shown as a carabiner, but it may be other hooks or securing fasteners.

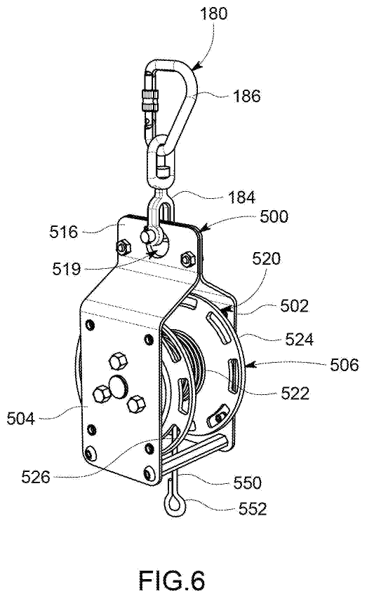

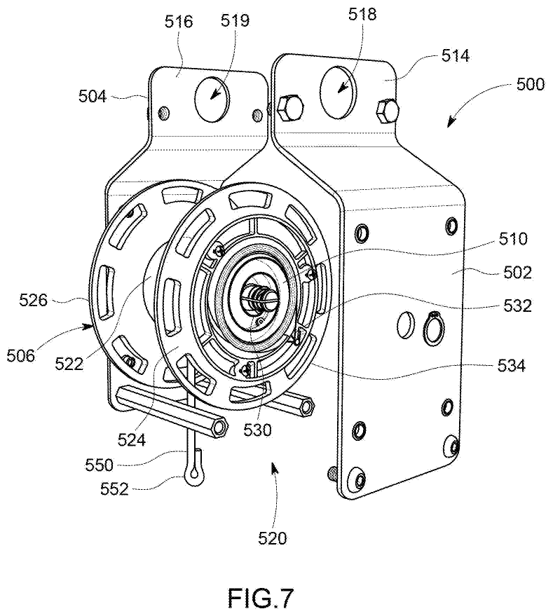

Referring to FIGS. 6, 7, 8, and 9, the device 100 also includes a retracting device 500 disposed inside the housing 102 and may include a pair of brackets, for example, a first bracket 502 and a second bracket 504, a winch 506 supported by the brackets 502, 504, and a spring 510 (shown in FIG. 7) attached to the winch 506, and a locking assembly 512 for braking and/or preventing a rotation of the winch 506 when a rotational speed of the winch 506 is above a threshold speed. The first bracket 502 is connected to the second bracket 504 and defines a space 520 therebetween. In an embodiment, a top end portion 514 of the first bracket 502 may abut a top end portion 516 of the second bracket 504, and is connected with the top end portion 516 of the second bracket 504. Further, the top end portion 514 defines a first hole 518 that aligns with a second hole 519 of the second bracket 504 upon an attachment of the first bracket 502 with the second bracket 504. Further, in an assembly of the retracting device 500 with the housing 102, the first hole 518 and the second hole 519 align with the through hole 190 of the housing 102. In this manner, the first hook 184 also passes through the first hole 518 and the second hole 519, and is connected to the first bracket 502 and the second bracket 504. This provides increased security connecting the hunter 300 to a cable 550, to the retractor 500, to the carabiner back up attachment 180, to the tree, so that even if the housing 102 structurally fails and/or the holder 106 fails, the hunter 300 is still safe from fall.

As shown, the winch 506 is disposed within the space 520 and includes a shaft 522 extending from the first bracket 502 to the second bracket 504 and rotatable supported by the first bracket 502 and the second bracket 504. The winch 506 further includes a first disk 524 supported by the shaft 522 and attached to the first bracket 502, and a second disk 526 supported by the shaft 522 and disposed proximate to the second bracket 504. As shown, the first disk 524 is attached to the first bracket, 502 such that the first disk 524 remains stationary upon a rotation of the shaft 522. Further, the second disk 526 is connected to the shaft 522 such that the second disk 526 rotates along with the shaft 522 upon the rotation of the shaft 522.

Further, the spring 510 includes a first end portion 530 connected to the shaft 522 and a second end portion 532 connected to the first disk 524. As shown, the second end portion 532 of the spring 510 is connected to the first disk 524 at a location proximate to an outer periphery 534 of the first disk 524. In an embodiment, the second end portion 532 of the spring 510 may be connected to the second bracket 502. In such a case the first disk 524 may be adapted to rotate along with the shaft 522. The spring 510 is adapted to bias the shaft 522 to a first position (initial position), and is adapted to resist a rotation of the shaft 522 from the first position. In this manner, the spring 510 is adapted to bring or rotate the shaft 522 back to the first position. In an embodiment, the spring 510 may be a flat spiral spring. Alternatively, the spring 510 may be a torsional spring.

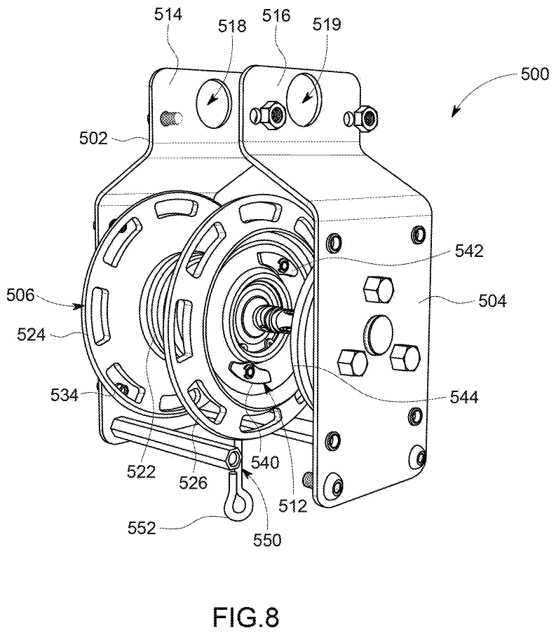

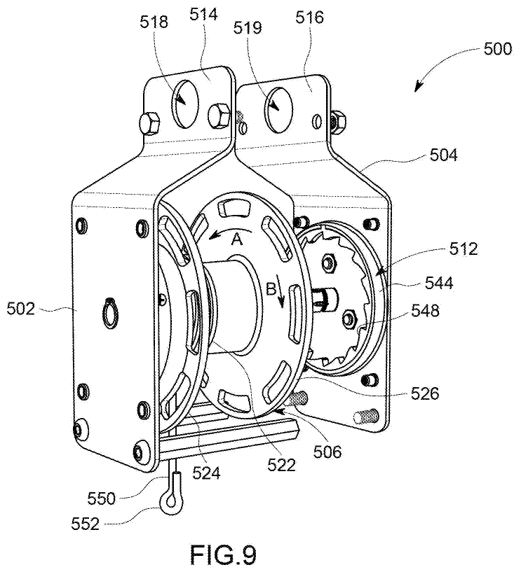

Referring to FIG. 8 and FIG. 9, the locking assembly 512 is adapted to automatically apply a brake to the shaft 522 and thereby prevent a rotation of the shaft 522 (winch 506) in response to a rotational speed of the shaft 522 exceeding the threshold speed. The locking assembly 512 include one or more levers, for example, a first lever 540 (shown in FIG. 8) and a second lever 542 (shown in FIG. 8), and a ratchet wheel 544 (shown in FIG. 9) having a plurality of teeth 548. The ratchet wheel 544 is engaged to the second disk 526 such that the second disk 526 is able to rotate relative to the ratchet wheel 544. Also, the ratchet wheel 544 is attached to the second bracket 504 using fasteners such that the ratchet wheel 544 remains stationary relative to the second bracket 504 upon rotation of the second disk 526. The first and/or second bracket 502, 504 is attached to the housing 102, so that the first and second brackets 502, 504 remain stationary relative to the housing. The first and/or second bracket 502, 504 may be attached directly to the housing 102, or attached to a metal or hard polymer reinforcement, that is itself attached to the housing 102. Further, the first lever 540 is pivotally connected to the second disk 526, and is adapted to pivot between a first position (shown in FIG. 8) and a second position. In the second position, the first lever 540 engages with the teeth 548 of the ratchet wheel 544. Similarly, the second lever 542 is pivotally connected to the second disk 526, and is adapted to pivot between a first position (shown in FIG. 8) and a second position. In the second position, the second lever 542 engages with the teeth 548 of the ratchet wheel 544. It may be appreciated that a structure, an assembly, and a function of the second lever 542 is similar to the first lever 540, and therefore, for the sake of clarity and brevity, a structure, a function, and an assembly of only the first lever 540 is explained. Further, although, two levers 540 are shown and contemplated, it may be envisioned that the locking assembly 512 may include a single lever or more than two levers.

The first lever 540 is pivotally attached to the second disk 526 such that the first lever 540 moves away from the first position, towards the second position, in response to the rotation of the second disk 526 (i.e. the shaft 522) reaching above a threshold speed. As a rotational speed of the shaft 522 exceeds the threshold speed, the first lever 540 reaches to second position due to the centrifugal force acting on the first lever 540, and contacts the teeth 548 of the ratchet wheel 540. In so doing, the locking assembly 512 applies the brake on the shaft 522 (i.e. the winch 506) and stops the rotation of the shaft 522 (i.e. the winch 506). In an embodiment, the first lever 540 is biased into the first position by a spring (not shown). In such a case, the first lever 540 returns to the first position from the second position upon a decrease of torque on the shaft 522 and locking assembly 512 below the spring bias of the spring 510.

Further, the device 100 includes a cable 550 having a first end attached to the retracting device 500 a second end 552 disposed outside or extending outwardly of the housing 102, and a latch 192 (best shown in FIGS. 2, 3, and 5) attached to the second end 552 of the cable and adapted to be attached to the hunter 300. Preferably, the cable measures between 15 and 40 feet in length, more preferably between 17 and 30 feet in length, and most preferably about 20 feet in length. Further, a portion of the cable 550 is wound around the shaft 522 and is contained in the winch 506, while a remaining portion of the cable 550 may hang from the winch 506. The cable 550 may be reeled out of the winch 506 by pulling the second end 552 of the cable 550 and thereby rotating the shaft in a first direction ‘A’ (shown in FIG. 9), while the cable 550 may reel in the winch 506 when the shaft 522 rotates in a second direction ‘B’ opposite to the first direction ‘A’. The shaft 522 may rotate in the second direction ‘B’ due the biasing force applied by the spring 510 on the shaft 522. Further, in some implementations, the cable 550 has a reflective portion 194 (shown in FIGS. 2, 3, and 5) disposed proximate to the second end 552 and including a material having a high reflectivity to facilitate a glowing of the reflective portion 194 in the dark. In an embodiment, a length of the reflective portion 194 may be between 6 inches to 18 inches. The reflective portion 194 may allow the cable 550 to be more easily seen with a flashlight in the dark. In an embodiment, the retracting device 500 may include a stopper for stopping a retraction of the cable 550 inside the housing 102 beyond a predefined limit.

An operation of the device 100 is now explained. At first, the hunter 300 may attach the device 100 to the tree 200 using the holder 106. For so doing, in an embodiment, the hunter 300 may climb to the tree stand 400 and wrap the first end portion 154 of the strap 150 and the second end portion 156 of the strap 150 around a trunk of the tree 200, and tightens the strap 150 using the ratchet 152. In so doing, the first side 116 of the housing 102 abuts the tree 200 and frictionally engages with the tree 200. In some other implementations, the hunter 300 may attach or affix the device 100 to the tree 200 while being on the ground. In such a case, the hunter 300 may use a projectile gun to shoot a projectile that embeds into the tree 200. The projectile may include a wire that remains attached to the projectile gun. Thereafter, the hunter 300 may attach the device 100 to the wire and may be winched/spooled up onto the tree 200 via a tether. When the device 100 reaches the tree 200 and contacts the tree 200, a switch disposed on the first side 116 of the housing 102 may get depressed that may cause the spool to stop. Further, the depressing of the switch may activate the arms 164, 166 such that the arms 164, 166 grip the tree 200 and the spikes 168, 170 embed into the tree 200. In an embodiment, the device 100 may include a proximity sensor that activates the arms 164, 166 when the first side 116 contacts the tree 200. In this manner, the retention assembly 162 facilitates an attachment of the device 100 with the tree 200 from the ground. The hunter 300 can then attach the latch 192 to the hunter's harness 193 while still on the ground, and the retention assembly 162 maintains stability while the hunter 300 makes the first climb. After climbing the tree stand 400, the hunter 300 may further attach the device 100 using the holder 106 as explained previously.

As the latch 192 is connected to the cable 550 and the retracting device 500, the hunter 300 is protected from sudden fall during hunting. In a scenario, the hunter 300 may lose contact from the tree stand 400 or ladder and fall towards the ground and a speed of reeling out of the cable 550 may reach above a predefined rate corresponding to threshold speed of shaft 522 before the hunter 300 hits the ground. In such a case, the reeling out of the cable 550 is stopped due to the brake applied by the locking assembly 512 owing to the engagement of the levers 540, 542 with the ratchet wheel 544. Therefore, the hunter 300 is prevented from hitting the ground and protected from falling. In practice, the retracting device stops a two-hundred-pound hunter free falling before one foot of cable is unwound, and preferably in under six inches of free falling. After the cable 550 is stopped, the hunter may climb back onto the stand or ladder. In another embodiment, after the cable 550 is stopped, an electric motor may automatically engage, and first wind the shaft 522 back up enough to allow the levers 540, 542 to return to respective initial positions, and then slowly reel out the cable 550, at a rate of between 1 and 5 feet per minute, for example. In this manner, the hunter 300 reaches the ground safely. In a further embodiment, the device 100 may be equipped with a microphone and after the detecting a fall, by the shaft 522 locking and a torque over a certain limit on the shaft 522 being detected by a sensor over a certain limit of time, for example, and wait to detect if the hunter states a key word or phrase such as “release,” and then unlocks the shaft 522 and lowers the hunter to the ground. In other embodiments, the device may just wait for any noise from the suspended hunter over a certain decibel level, such as 60, 65, 70, 75, 80, 85, or 90 decibels, for example. Therefore, in normal use, the retracting device 500 reels in cable 550 as a hunter 300 climbs the tree 200, and allows for the cable 550 to reel out from the housing 102 at a slow rate i.e. below the predefined rate (threshold speed) as a hunter moves about or descends a ladder, but automatically stops the reeling out of the cable 550 if a rate (speed) of reel out of the cable 550 exceeds the predefined rate.

The invention illustratively disclosed herein suitably may explicitly be practiced in the absence of any element which is not specifically disclosed herein. While various embodiments of the present invention have been described in detail, it is apparent that various modifications and alterations of those embodiments will occur to and be readily apparent those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items while only the terms “consisting of” and “consisting only of” are to be construed in the limitative sense.

Wherefore I claim:

1. A tree safety device comprising:
a housing;
a holder attached to the housing to hold the device to a tree;
an automatic breaking retractor inside of the housing;
a cable, with a first end attached to the retracting device and a second end extending out of the housing;
a latch attached the second end of the line;
wherein the retractor allows for the cable to be fed from the housing at a rate below a predetermined speed, but automatically breaks the cable from feeding out of the housing if the rate exceeds the predetermined speed.

2. The tree safety device of claim 1 wherein the housing has a first side that is concave to fit increase surface area in contact with the tree.

3. The tree safety device of claim 1 wherein the housing has a tree first side designed to contact the tree, and wherein projections are disposed on an exterior surface of the first side.

4. The tree safety device of claim 1 wherein the holder incudes a strap.

5. The tree safety device of claim 4 wherein the holder includes a ratchet that tightens the strap.

6. The tree safety device of claim 4 wherein the strap has protrusions on a tree facing inner surface of the strap. The tree safety device of claim 4, further comprising one or more hooks or rings disposed on the strap.

8. The tree safety device of claim 4 further comprising a groove channel disposed on an exterior surface of a second side of the housing to position the strap around a front of safety device facing away from the tree.

9. The tree safety device of claim 4 wherein the housing comprises a first and a second handle defining a first and a second through hole in housing, such that the strap is fed through each of the first and the second through hole, with the first and the second handle being of unitary construction with the housing.

10. The safety device of claim 4, wherein the cable has one of glow in the dark material and highly reflective material, between 6 inches and 18 inches in length, adjacent to the second end of the chord to allow the chord to be to be more easily seen with a flashlight in the dark.

11. The safety device of claim 1, wherein the interior is substantially isolated from the weather, with any open hole into the interior positioned on a ground facing side.

12. The safety device of claim 1 further comprising a carabiner back up attachment at top of the housing.

13. The safety device of claim 3, wherein projections are one of teeth that angle downward when attached to a tree and spikes that are arranged orthogonal to the housing surface.

14. The safety device of claim 1, wherein the housing is UV resistant and weather resistant.

15. The safety device of claim 4, wherein the strap is weather and UV resistant.

16. The safety device of claim 1, wherein the housing is one of camouflaged and orange.

17. The safety device of claim 1 further comprising a retention assembly including a first arm and a second arm that engage the tree frictionally retain the device.

18. The safety device of claim 17, wherein the first and second arms are mechanized and automatically grip the tree once the device is placed adjacent to the tree.

19. The safety device of claim 1, wherein the retractor defines a retractor through hole that is aligned with a third through hole in top of the housing.

20. The safety device of claim 19, wherein the carabiner back up attachment includes a first hook that attaches to the housing at the third through hole.
